(19) United States
(12) Patent Application Publication
(10) Pub. No.: US 2017/0212361 A1
(43) Pub. Date: Jul. 27, 2017

(54) Optimal Focusing Design for High Field of View Head Mount Displays

(71) Applicant: Terrence A. Staton, Nashville, NC (US)

(72) Inventor: Terrence A. Staton, Nashville, NC (US)

(21) Appl. No.: 15/413,982

(22) Filed: Jan. 24, 2017

Related U.S. Application Data
(60) Provisional application No. 62/286,585, filed on Jan. 25, 2016.

(51) Int. Cl. G02B 27/40; G02B 7/12

(52) U.S. Cl. CPC G02B 27/40; G02B 7/12; G02B 3/08

(57) ABSTRACT

A head mount display (HMD) provides optimal means of focusing a high field. The HMD employs a pair of lenses to magnify the image from a pair of display panels. By mechanically moving the display panels substantially parallel to the lens in an HMD design, it is possible to bring the human eye close to the lens while presenting an in-focus image for the majority of users while keeping the user adjustment mechanics for focus and comfort quick and simple.

### CROSS-REFERENCE TO RELATED APPLICATIONS

This application claims the benefit of U.S. Provisional Patent Application No. 62/286,585 titled “Optimal Focusing Design for High Field of View Head Mount Displays,” filed 25 Jan. 2016, incorporated herein by reference.

### BACKGROUND OF THE INVENTION

1. Field of the Invention

The present invention relates to virtual reality (VR) head mount displays (HMDs), and more specifically, it relates to high Field of View (FOV) HMDs with Quad HD resolution.

2. Description of Related Art

Since the success of the Oculus Rift there has been much research into taking smart phone display screens originally designed for mobile devices and using them in Virtual Reality (VR) Head Mount Displays (HMDs). With the invention of the Oculus Rift it was clear that a high-quality HMD was possible with a low price point by using such panels. A great amount of research and development is now being done by many parties/companies into commercial VR technology as a result. Given that 360 3D video needed a high Field of View (FOV) HMD with Quad HD resolution, the present inventor began designing HMDs.

The problem space is to create a comfortable, stress -free, high FOV and high resolution HMD. The goal is to make the user feel they are completely immersed into a computer rendered environment with the visual and audio senses fully engage. Head Rotated Transfer Function (HRTF) binaural audio solved the main audio issues long ago, but the visual aspects have not vet been resolved. It is desired to create a VR visual experience that is very integrated with how human vision works. If the HMD creates even the slightest eye strain, then the user may experience some long-lasting side effects from using the HMD. This is very undesirable. It is even argued by a few neuroscientists that the 110 degree FOV of the planned Oculus Rift consumer version will potentially create diminished peripheral vision function with prolonged usage. The problem lies in the chosen optics. Traditional double converging optics limits the possible FOV to around a maximum of 110 degrees. Another lens technology is needed.

### SUMMARY OF THE INVENTION

The invention presents optimal means of focusing high field of view HMDs that employ a pair of single lens to magnify the image from a pair of display panels. By mechanically moving the display panels substantially parallel to the lens in an HMD design, it is possible to bring the human eye close to the lens while presenting an in-focus image for the majority of users while keeping the user adjustment mechanics for focus and comfort quick and simple.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 shows focus of a HMD with a Fresnel Lens.

FIG. 2 illustrates adjusting a HMD Focus by a Moving Display Panel of the present invention.

FIG. 3 is a drawing of an embodiment that implements aspects of the present invention.

FIG. 4 is a cross-sectional drawing of embodiment that implements aspects of the present invention.

FIG. 5 shows an embodiment that implements aspects of the present invention.

FIG. 6 is a cross-sectional drawing of embodiment that implements aspects of the present invention.

### DETAILED DESCRIPTION OF THE INVENTION

The present inventor's research and development resulted in a conclusion that the use of Fresnel lens technology was the best optical technology available to reach high FOV. (The invention is not limited to Fresnel lens technology, as other lens types are useable.) One prototype was capable of reaching a FOV of 210 degrees. The increase in FOV comes from the cantering of the two mobile display panels and the use of Fresnel lenses. Standard circular grooved Fresnel lenses did not create an image that was completely in focus. Thus, a custom Fresnel lens would be required. He designed a unique Fresnel lens and experienced a huge increase in image sharpness and clarity. For perfect image focus further lens design is needed. To create an image perfectly in focus an extremely large exit pupil Fresnel lens was needed. Lens design aside, another issue specifically addressed herein is adjustment of the focal path between the display and the lens.

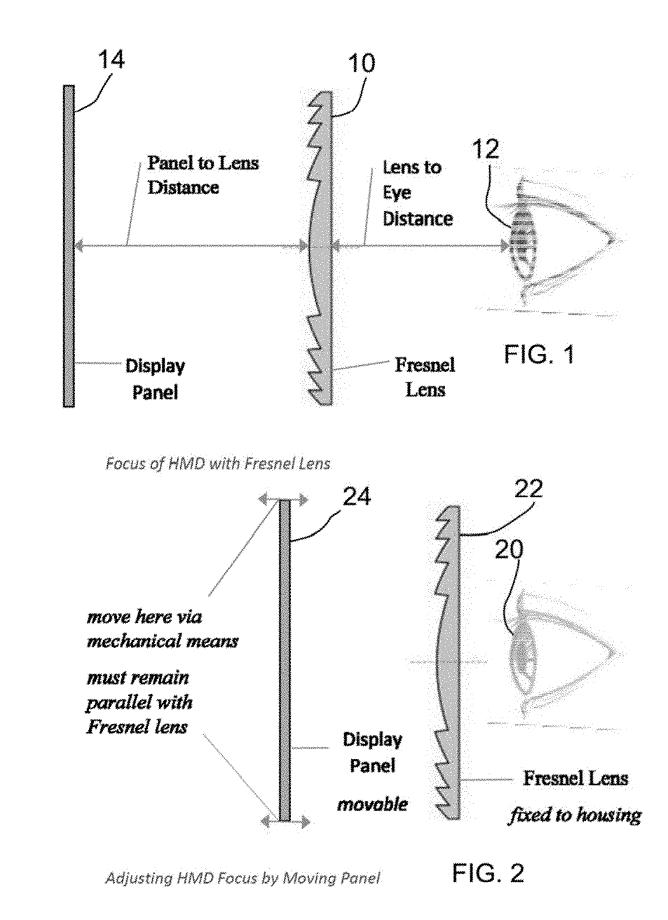

In the diagram shown in FIG. 1, it is desired to adjust the lens 10 to eve 12 distance for comfort, including, if required by the user, the use of corrective eye wear (glasses,) and bring the eye as close as to the Fresnel lens as is comfortable in order to maximize FOV. The distance from panel 14 to the lens is adjusted. to bring the image into locus. For people with perfect 20/20 vision, this distance should be the focal length of the Fresnel lens.

Given the variation in the ability of the human eye to focus, any mass-produced HMD needs the ability to accommodate the focus-ability for as much of the population as possible. Traditional HMDs have always had mechanisms to increase/reduce the focal distance from the field optics/mirrors to the eye-piece lens (the lens closest to the eye). The need for field optics and mirrors has been completely eliminated by using mobile display panels instead of postage stamp sized displays. This is due to the optical magnification power needed being greatly reduced. Now there is only the eye-piece lens and the mobile display as shown in the diagram of FIG. 1. The lens functions just like a magnifying glass with the eye brought close to it. With this simplification, the HMD designer has the following options to adjust image focus: (1) create a mechanism to move the display further/closer from the lens, (2) create a mechanism to move the lens further/closer to the display, (3) offer swappable lenses with different focal lengths and (4) allow the user to use their own corrective lenses. The Oculus Rift DK1 and DK2 used a combination of solution number #2, #3 and #4.

The pros and cons of each approach are discussed below. Solutions 1 and 2 enable the HMD to be adjusted via a mechanical mechanism to let the user adjust focus. This is economically attractive and will achieve perfect focus for the majority of users. The cons with solutions 1 and 2 is that they can make the device easier to damage from physical impacts due to having moving parts. More care has to be take in the HMD's design and structure to prevent such damage. Another con is it will not correct for astigmatism. Solution 3 can result in an HMD that is better able to handle physical impacts and has the potential for creating custom lenses for users with astigmatism or extreme visual correction requirements. The possibility for creating custom lenses for everyone may not be economically viable or profitable. Also, swapping lenses introduces an array of problems for non-tech savvy users. Solution 4 creates an HMD that can handle physical impacts well and is guaranteed to create optimal focus for the user. A con to solution 4 is the need for a mechanical adjustment to move the lens closer/further from the eye. Using corrective lenses (glasses) requires the lens to be moved further from the eye, thus reducing the field of view experienced by the user. Given that there are some extreme eye correction circumstances, any mass-produced HMD must have solution 4 as part of its design.

Since solution 4 is required and solution 3 is not attractive, the question comes down to which is better, solution 1 or solution 2? It is herein proposed that solution 1 is a vast improvement over solution 2 for the following reasons. By mechanically moving the display to adjust the focal path distance instead of the eye-piece lens, it allows the design of a large eye-piece lens that can (i) closely contour around the nose, (ii) be very close to the eye and (iii) have a large FOV lens hard mounted to the HMD housing, thus simplifying the design of the HMD. A further benefit is that the image focus can be adjusted independently of adjustments made for physical comfort. This is especially important for users who wear glasses. If solution 2 is used, then adjusting image focus could have the eye piece lens touch the user's glasses, thus requiring readjustment of the eye piece lens-to-eye distance. Still another benefit results in that combining (i) and (ii) together it is possible to create an HMD with super human like vision where the nose does not obstruct the field of view for users who do not need to wear glasses with the HMD. Again, it is herein concluded that solution 1, moving the display panel instead of the eye piece lens to adjust focus, results in a HMD that functions with a higher field of view for as many users as possible.

FIG. 2 shows an implementation of solution 2 wherein the Fresnel lens 22 remains fixed relative the eye 20 and the housing (not shown) of the HMD while the display 24 is movable via mechanical means. The surface of the Fresnel lens and the display panel must always remain substantially parallel to each other for optimal performance. Mechanical means for moving the panel can be anything from gears, to lead screws or sliders. Enough mechanical friction is required so the panel does not move unless directly intended by the user for focusing purposes.

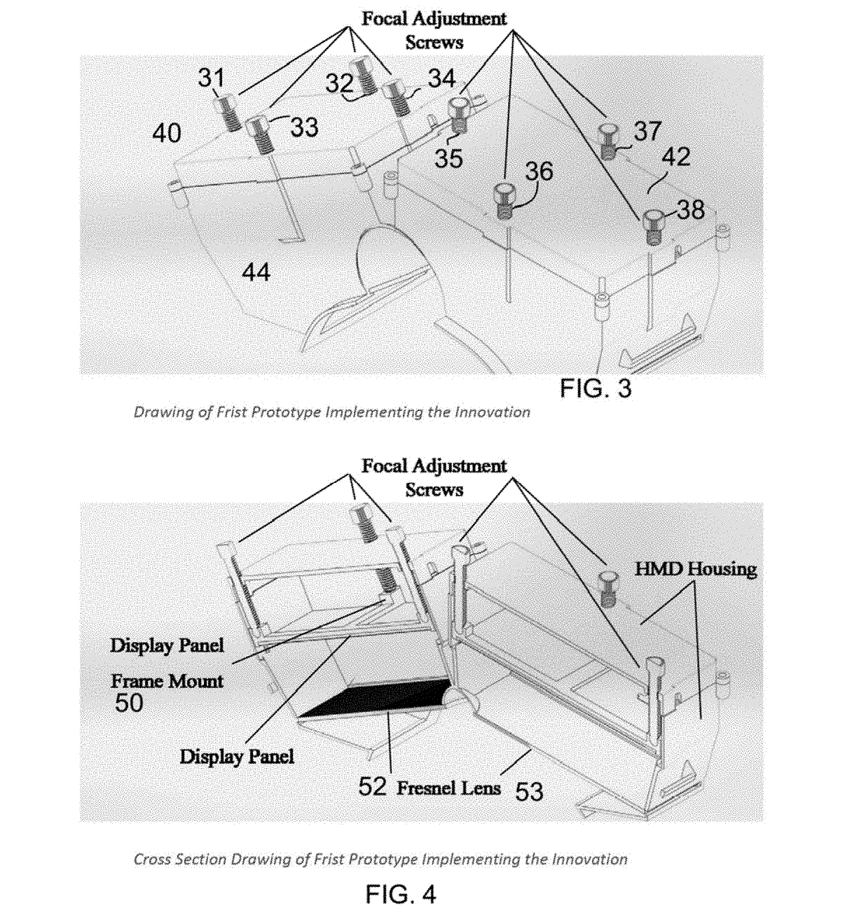

FIG. 3 shows a drawing of an embodiment that was built which implemented aspects of the present invention. Four focal adjustment screws 31-34 per display panel 40 and 35-38 per display panel 42 are attached to HMD 44 and are used instead of one screw. This was done to test the effects of the display panel being at slight angles away from parallel to the Fresnel lens. FIG. 4 shows a cross sectional drawing of a portion of the embodiment of FIG. 3 and further shows display panel frame mounts 50, 51 and Fresnel lenses 52, 53. It makes it clear how turning the focal adjustment screws will change the distance of the display panel from the Fresnel lens. This embodiment required small incremental adjustments to all the screws in an interleaved or iterative manner to prevent bending to the display panel. Through testing of this prototype, it was discovered the most pleasing visual image eras obtained with the display panel that was perfectly parallel with the Fresnel lens.

In one embodiment of FIGS. 3 and 4, the Fresnel lens can slide horizontally within the HMD housing to adjust for interpupillary distance. Interpupillary distance is the distance between the pupils of the left and right eye when looking directly ahead. For males, this distance often ranges from 52 mm to 78 mm and for females, from 52 mm to 76 mm. The prototype was designed to accommodate this range of interpupillary distance. Since there is no movement of the lenses to or from the eye, a simple slider mechanism of the lenses is used for interpupillary adjustment. The prototype shown in FIGS. 3 and 4 confirmed that focal adjustments by moving the display panel instead of the lenses greatly simplifies interpupillary adjustment.

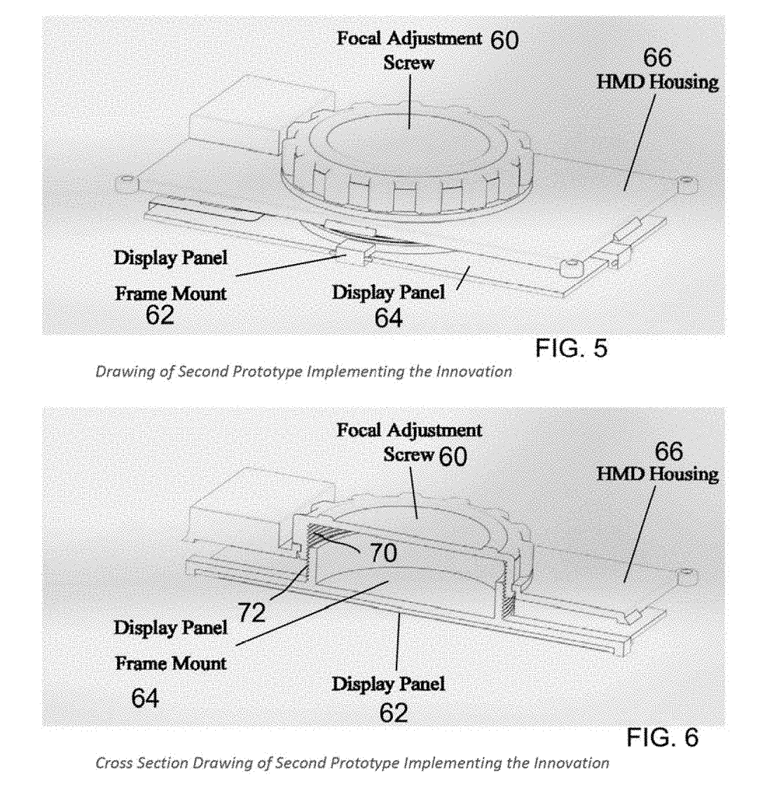

FIG. 5 shows a sub-assembly drawing of a second embodiment (prototype) that implements an aspect of the present invention. It uses a single large screw 60 per display panel to adjust the movement of the display panel frame mount 62 and display mount 64 within the HMD housing 66. It greatly simplifies the focus mechanism by taking, advantage that the display panel must be in parallel with the Fresnel lens at all focal distances. FIG. 6 shows a cross sectional view of this prototype. It can be seen that the focusing screw 60 snaps into the HMD housing 66. After snapping into place, it can rotate freely, but its distance relative to the HMD housing remains fixed into place. Rotating the screw, which includes inner treads 70 which mate to threads 72 which are part of the display mount frame panel 62, will move the whole display panel frame mount and the display panel 64. The display panel will always be perpendicular to the axis of rotation of the Screw and thus keep the display panel parallel to the Fresnel lens.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

I claim:

1. An apparatus, comprising:
a pair of lenses in a head mount display (HMD) housing, wherein the distance between said lenses is adjustable to the interpupillary distance of a user, wherein said pair of lenses are otherwise fixed into place relative to said housing;
a display panel within said housing, wherein said display panel can move instead of said lens in order to adjust image focus of the image from said panel as required for the user.

2. The apparatus of claim 1, including means for moving said display panel instead of said lens such that the display panel moves along one axis (for said image focus) and the lens can move along only one axis (for said interpupillary distance).

3. The apparatus of claim 1, wherein said lenses moves only to accommodate for said interpupillary distance.

4. The apparatus of claim 3, wherein said lenses substantially contour to the shape of the human nose.

5. The apparatus of claim 1, wherein the shape of said lenses is designed for human comfort without impacting said image focus.

6. The apparatus of claim 1, further comprising means for adjusting said image focus such that eye-to-lens distance is substantially unaffected.

7. The apparatus of claim 1, including means for allowing eye corrective lenses to be used.

8. The apparatus of claim 1, wherein said lenses each comprise a near eye magnifying lens such as Fresnel lens, hybrid Fresnel lens or conventional lens.

9. The apparatus of claim 1, wherein said lenses are designed for near eye magnification with a exit pupil 7 to 17 mm and a focal length of 50 mm to 85 mm.

10. A method for using the apparatus of claim 1, wherein said method comprises adjusting said interpupillary distance.

11. The method of claim 10, further comprising adjusting the position of said display panel to change the distance between the eyes of the user and said display panel.

12. An apparatus, comprising:
a head mount display (HMD) housing;
a display panel positioned in said HMD housing;
a pair of near eye magnifying lenses mounted in said HMD, wherein said pair of lenses are positioned and configured to collect light from said display panel and produce an image;
means for adjusting said pair of lens to adjust for the interpupillary distance of a user of said apparatus, wherein said pair of lenses are otherwise fixed relative to said housing; and
means for moving said display panel relative to said pair of lenses to adjust the focus of said image as it is received by the eyes of the user.

13. The apparatus of claim 12, wherein the lenses substantially contour to the shape of the human nose.

14. The apparatus of claim 12, wherein the shape of lens is designed for human comfort without impacting image.

15. The apparatus of claim 12, further comprising means for adjusting image focus such that eye-to-lens distance is substantially unaffected.

16. The apparatus of claim 12, including means for allowing eye corrective lenses to be used.

17. The apparatus of claim 12, wherein said lens is designed with an exit pupil 7 to 17 mm and a focal length of 50 mm to 85 mm.
